(19) United States
(12) Patent Application Publication
(10) Pub. No.: US 2026/0128338 A1
(43) Pub. Date: May 7, 2026

(54) A METHOD OF OPERATING A CELL SYSTEM HAVING AT LEAST ONE ELECTROCHEMICAL CELL, A CELL SYSTEM, AND A COMPUTER PROGRAM

(71) Applicant: Robert Bosch GmbH, Stuttgart (DE)

(72) Inventors: Sebastian Egger, Radolfzell Am Bodensee (DE); Alexander Konstandin, Binau (DE); Felix Eberhard Hildebrand, Stuttgart-West (DE); Ingo Kerkamm, Stuttgart (DE); Markus Klinsmann, Stuttgart (DE); Maxime Carre, Stuttgart (DE); Sebastian Schmaderer, Stuttgart (DE)

(21) Appl. No.: 18/880,947

(22) PCT Filed: Jun. 28, 2023
(86) PCT No.: PCT/EP2023/067614

§ 371 Date: Jan. 3, 2025

(30) Foreign Application Priority Data
Jul. 4, 2022 (DE) 10 2022 206 808.4

(51) Int. Cl. H01M 8/04992; H01M 8/0432; H01M 8/10

(52) U.S. Cl. CPC H01M 8/04992; H01M 8/0432; H01M 2008/1095

(57) ABSTRACT

The invention proceeds from a method of operating a cell system (22) having at least one electrochemical cell (24).

It is proposed that at least one operational parameter of a temperature control unit (30) of the cell system (22) is set depending on at least one internal temperature parameter of the cell system (22).

### BACKGROUND

Methods for operating a cell system having at least one electrochemical cell have already been proposed.

### SUMMARY

The invention proceeds from a method of operating a cell system having at least one electrochemical cell.

It is proposed that at least one operational parameter of a temperature control unit of the cell system is set depending on at least one internal temperature parameter of the cell system.

By the embodiment of the method according to the invention for operating the cell system, an operation of the cell system outside of a provided temperature range can be counteracted particularly precisely and efficiently. Advantageously, the cell system can be operated particularly carefully. Advantageously, temperature-related damage to the cell system can be counteracted particularly efficiently and precisely. Advantageously, a particularly efficient and at the same time safe operation of the cell system can be enabled. Advantageously, a particularly durable cell system can be provided. Advantageously, the cell system can be controlled in a particularly dynamic manner.

The electrochemical cell is preferably formed as a solid oxide fuel cell. Alternatively, however, it is also contemplated that the electrochemical cell may be formed as another fuel cell, for example a polymer electrolyte membrane fuel cell or the like, as an electrolytic cell or as an accumulator cell. For example, alternatively, it is also contemplated that the electrochemical cell is used in an electrolyzer. It is contemplated that the cell system comprises only one, in particular the electrochemical cell already mentioned above, or that the cell system comprises a plurality of electrochemical cells, for example two, three or several hundred electrochemical cells. Preferably, the electrochemical cells of the cell system comprising a plurality of electrochemical cells are aggregated into a stack and in particular connected in series. It is also contemplated that the cell system comprises a plurality of stacks formed from a plurality of electrochemical cells, preferably aggregated to form a module or tower.

The cell system preferably comprises a control unit. The control unit is in particular provided to perform the method to operate the cell system. The term “provided” is preferably intended to mean specifically designed, specifically configured, and/or specifically equipped. An object being provided or designed for a specific function is understood to mean that the object fulfills and/or performs this specific function in at least one application and/or operating state. In particular, the control unit comprises at least one processor and one memory element, as well as an operating program stored on the memory element. The memory element is preferably designed as a digital storage medium, e.g., a hard disk or the like. In particular, the cell system comprises a housing in which preferably the at least one electrochemical cell or stack formed by a plurality of electrochemical cells is disposed. It is contemplated that the control unit is disposed at least partially on, in particular at least partially in, the housing. Alternatively or additionally, it is also contemplated that the cell system comprises an external unit, wherein the external unit comprises at least a part of the control unit. For example, the external unit may be a cloud, a server, or the like. It is contemplated that the external unit comprises the memory element of the control unit.

The temperature control unit preferably comprises at least one blower unit. The temperature control unit, preferably the blower unit, is provided in particular to generate an air flow rate, preferably on a cathode side of the cell system. The oxygen ions required for an electrochemical reaction of the cell system, which preferably comprises fuel cells, are provided by means of the blower unit, preferably by means of the air flow rate generated by the blower unit. The cell system, in particular the at least one electrochemical cell or the stack formed by a plurality of electrochemical cells, is preferably temperature controlled by means of the temperature control unit. The cell system, in particular the at least one electrochemical cell or the stack formed by a plurality of electrochemical cells, is in particular cooled or heated by means of the temperature control unit. Preferably, the blower unit is provided for generating an air flow rate for cooling the cell system, in particular the at least one electrochemical cell or stack formed by a plurality of electrochemical cells. Alternatively or additionally, it is conceivable that the blower unit is provided to generate an air flow rate, preferably pre-heated, for heating the cell system, in particular the at least one electrochemical cell or the stack formed by a plurality of electrochemical cells. It is contemplated that the blower unit may comprise one fan or multiple fans.

Alternatively or additionally, it is conceivable that the temperature control unit comprises a heating unit for heating the cell system, in particular the at least one electrochemical cell or the stack formed by a plurality of electrochemical cells, for example for heating the air flow rate generated by the blower unit. The heating unit is preferably configured as an electric heating unit. In particular, the heating unit comprises at least one heating element, preferably an electric heating element. Alternatively, however, it is also conceivable that the heating unit is configured as a fluid-based heating unit, in particular as a liquid-based heating unit and/or as a gas-based heating unit. The fluid-based heating unit is particularly provided for heating the cell system, in particular the at least one electrochemical cell or stack formed by a plurality of electrochemical cells, using a fluid. The liquid-based heating unit is particularly provided for heating the cell system, preferably the at least one electrochemical cell or stack formed by a plurality of electrochemical cells, by means of a liquid, for example water or the like. The gas-based heating unit is particularly provided for heating the cell system, preferably the at least one electrochemical cell or stack formed by a plurality of electrochemical cells, using a gas. Further, it is contemplated that the heating unit may be configured as a combination of a fluid-based heating unit, in particular a gas-based heating unit and/or a liquid-based heating unit, and an electric heating unit.

Alternatively or additionally, it is also contemplated that the temperature control unit comprises a liquid cooling unit for cooling the cell system, in particular the at least one electrochemical cell or the stack formed by a plurality of electrochemical cells. The fluid cooling unit is particularly provided to cool the cell system, preferably the at least one electrochemical cell or stack formed by a plurality of electrochemical cells, using a fluid. The liquid cooling unit is particularly provided for cooling the cell system, preferably the at least one electrochemical cell or stack formed by a plurality of electrochemical cells, using a liquid, for example water or the like. It is contemplated that the liquid cooling unit is formed to be at least partially integral with the liquid-based heating unit. By the fact that “at least one unit and at least one further unit are at least partially designed integrally with one another”, it is to be understood in particular that at least one element of the unit is designed integrally with at least one further element of the further unit. The term “integral” is in particular understood to mean connected at least by substance-to-substance bonding, e.g., by a welding process, an adhesive bonding process, a process of molding on, and/or another process that appears advantageous to the skilled person, and/or advantageously formed in one piece, e.g., by production from a casting and/or by production in a single-or multi-component injection molding process and advantageously from a single blank. It is also contemplated that the gas cooling unit is formed to be at least partially integral with the gas-based heating unit. The gas cooling unit is particularly provided to cool the cell system, preferably the at least one electrochemical cell or stack formed by a plurality of electrochemical cells, using a gas.

The at least one operational parameter of the temperature control unit may preferably comprise a heating power of the, in particular electrical, heating unit, a flow rate, in particular, a flow rate of the blower unit, a flow rate of the fluid-based heating unit, in particular, a flow rate of the liquid-based heating unit and/or a flow rate of the gas-based heating unit, a flow rate of the fluid cooling unit, preferably a flow rate of the liquid cooling unit and/or a flow rate of the gas cooling unit, or the like. In particular, the internal temperature parameter is a cell parameter of the cell system, preferably an internal parameter of the cell system.

It is further proposed that the internal temperature parameter be determined based on a physical model of the cell system. In particular, at least one aging parameter of the cell system is determined based on the physical model. In addition, it is conceivable that at least one further cell parameter of the cell system, preferably a further internal parameter of the cell system, is determined based on the physical model. The physical model is preferably a simulation model of the cell system, which in particular describes a steady state operation of the cell system. Preferably, the physical model is based on the finite element method. In particular, the physical model is unambiguously invertible with regard to the aging parameter of the cell system. It is contemplated that the physical model will be unambiguously invertable with respect to the aging parameter at least by filtering out physically irrelevant results of the physical model. For example, according to a publication by Zaccaria, Tucker and Traverso entitled “A distributed real-time model of degradation in a solid oxide fuel cell” (2016, Journal of Power Sources 311, 175-181), the physical model may describe a degradation of the cell system comprising solid oxide fuel cells, wherein an ohmic portion of internal voltage losses is assigned the aging parameter as a pre-factor. Alternatively, it is also conceivable, for example, that other resistors of internal voltage losses differing from the ohmic portion, in particular the concentration losses or polarization losses, of the cell system or an overall internal resistance of the cell system, are multiplied by the aging parameter as a pre-factor. In the preferred physical model, in particular, an overall specific surface resistance of the cell system is multiplied by the aging parameter. The aging parameter is in particular a cell parameter of the cell system. The aging parameter preferably describes an aging state of the cell system. For example, in an unaged state of the cell system, the aging parameter has a value of 1, and preferably a value greater than 1, for an aged state of the cell system. The aging parameter is preferably a scalar parameter. Advantageously, the internal temperature parameter can be determined with a particularly low need for sensor technology. Advantageously, the internal temperature parameter, which requires a particularly high use of sensor technology to record, can be determined particularly easily.

Furthermore, it is proposed that the internal temperature parameter be determined on the basis of the physical model of the cell system as a function of the operational parameter of the cell system, preferably by means of the control unit. Preferably, the aging parameter is determined based on the physical model as a function of operational parameters of the cell system, preferably by means of the control unit. In addition, it is conceivable that the at least one further cell parameter, in particular the at least one further internal parameter of the cell system, is determined based on the physical model as a function of the operational parameters of the cell system. In particular, the physical model has at least one input parameter and at least one output parameter. Preferably, the at least one input parameter of the physical model comprises at least one of the operational parameters of the cell system, in particular at least one input parameter of the cell system, preferably at least one operational parameter of the cell system. Preferably, at least one further input parameter of the physical model is the aging parameter. For example, the operational parameter of the cell system is a requested load current, a temperature, particularly a gas temperature, a volumetric flow rate, an air efficiency level, a fuel efficiency level, a gas composition, a pressure, a pressure difference, or the like. Preferably, the at least one output parameter of the physical model comprises at least one operational parameter of the cell system, in particular at least one output parameter of the cell system, preferably at least one performance parameter of the cell system. The performance parameter of the cell system is in particular an output voltage of the electrochemical cell, preferably the stack formed by a plurality of electrochemical cells. It can be contemplated that the output parameters of the physical model comprise the at least one further cell parameter, in particular the at least one further internal parameter, of the cell system. Preferably, the internal temperature parameter is an output parameter of the physical model. The internal temperature parameter is preferably a temperature of the cell system, preferably of the at least one electrochemical cell or stack formed by a plurality of electrochemical cells. The internal temperature parameter is preferably a local field size. The at least one further cell parameter, in particular an internal parameter, of the cell system is preferably a local field size, for example a fluid distribution, preferably an oxygen distribution or a hydrogen distribution, in the cell system, a current density distribution in the cell system, or the like. The physical model in particular depicts a mapping which maps the input parameters of the physical model, preferably the at least one operational parameter of the cell system and the aging parameter of the cell system, to the output parameters of the physical model, preferably to the at least one performance parameter of the cell system and to the internal temperature parameter, and in particular to the at least one further cell parameter of the cell system. Advantageously, particularly easy-to-sense parameters of the cell system can be used to determine the internal temperature parameter. Advantageously, the internal temperature parameter, as a function of which the at least one operational parameter of the temperature control unit is set, can be determined with a particularly low need for sensor technology.

In addition, it is proposed that the operational parameters comprise at least one, in particular the previously mentioned, input parameter of the cell system. It is contemplated that the operational parameters, depending on which at least the internal temperature parameter is determined based on the physical model of the cell system, comprise only the one input parameter of the cell system or a plurality of input parameters of the cell system. Advantageously, particularly easy-to-sense parameters of the cell system, in particular the at least one input parameter of the cell system, can be used to determine the internal temperature parameter. Advantageously, the internal temperature parameter can be determined with a particularly low need for sensor technology.

In addition, it is suggested that the input parameter comprises at least one, in particular the aforementioned, operational parameter of the cell system. In particular, the input parameter corresponds to the operational parameter of the cell system. It can be contemplated that the at least one operational parameter of the cell system is a variable or a control variable, in particular an actual value or a target value of the control variable, of the cell system. Advantageously, particularly easy-to-sense parameters of the cell system, in particular the at least one operational parameter of the cell system, can be used to determine the internal temperature parameter. Advantageously, the internal temperature parameter can be determined with a particularly low need for technology. Advantageously, at least in some cases parameters of the cell system that are already sensed for operation of the cell system can be used to determine the internal temperature parameter.

It is further proposed that the operational parameters comprise at least one, in particular the previously mentioned, output parameter of the cell system. It is contemplated that the operational parameters comprise only the one output parameter of the cell system or a plurality of output parameters of the cell system, depending on which the internal temperature parameter is determined based on the physical model of the cell system. Advantageously, particularly easy-to-sense parameters of the cell system, in particular the at least one output parameter of the cell system, can be used to determine the internal temperature parameter. Advantageously, the internal temperature parameter can be determined with a particularly low need for technology. Advantageously, at least in some cases parameters of the cell system that are already sensed for operation of the cell system can be used to determine the internal temperature parameter.

It is further suggested that the initial parameter comprises at least one, in particular the aforementioned performance parameter of the cell system. In particular, the output parameter corresponds to the performance parameter of the cell system. Preferably, the operational parameters are sensed at least in part on the cell system. Preferably, at least the performance parameter, in particular the output voltage, of the cell system is sensed on the cell system, preferably using sensors. Preferably, the cell system comprises a sensing unit for at least partially sensing the operational parameters. The sensing unit is preferably connected to the control unit via data technology, in particular for wireless and/or wired data transmission. It is also contemplated that the control unit at least partially comprises the sensing unit. It is contemplated that the operational parameters configured as input parameters of the cell system and/or the operational parameters configured as output parameters of the cell system are sensed at least in part, preferably via sensor technology, preferably by means of the sensing unit. For example, the sensing unit comprises at least one sensor unit for at least partially sensing the operational parameters. The sensing unit is preferably configured to sense at least the output parameter configured as the performance parameter, in particular using sensors. For example, the sensor unit comprises at least one voltage sensor, in particular for sensing the performance parameter of the cell system configured as the output voltage. It is contemplated that the sensing unit is configured to detect at least one input parameter of the cell system configured as an operational parameter of the cell system. Additionally or alternatively, it is conceivable that the at least one input parameter, preferably the input parameter configured as a variable or control variable, in particular the target value of the input parameter configured as the control variable, is read directly via the control unit, preferably provided by the control unit. Advantageously, particularly easy-to-sense parameters of the cell system, in particular the at least one performance parameter of the cell system, can be used to determine the internal temperature parameter. Advantageously, the internal temperature parameter can be determined with a particularly low need for technology. Advantageously, at least in some cases parameters of the cell system that are already sensed during operation of the cell system can be used to determine the internal temperature parameter.

Furthermore, it is proposed that the physical model be inverted and optimized to determine the internal temperature parameter, in particular with respect to the aging parameter. Preferably, the physical model is inverted and optimized with respect to the aging parameter, which is in particular one of the input variables of the physical model, to determine the aging parameter and to preferably subsequently determine the internal temperature parameter and preferably the at least one further cell parameter, and in particular as a function of the determined aging parameter. Preferably, time series are formed based on the operational parameters. Preferably, in a method step, in particular in a sensing step, the operational parameters, preferably the at least one input parameter and the at least one output parameter are recorded over time. Preferably, the recorded operational parameters are stored as time series on the control unit, in particular on the memory element of the control unit. Preferably, in a method step, in particular in a selection step, a time is selected from the time series of the operational parameters, preferably by the control unit, wherein the control unit is particularly provided for determining at least the aging parameter for the selected point in time. Preferably, the control unit is provided to select the point in time from the time series of the operational parameters such that an associated system state of the cell system at the time can be described by the physical model. For example, it is conceivable that the physical model is only applicable to steady state conditions, in particular input parameters of the cell system, so that sufficient steady state operational parameters are to be used accordingly. It is also contemplated that the operational parameters may be at least partially pre-processed, for example oscillations or the like may be removed by a filter. It is contemplated that the operational parameters, in particular the at least one input parameter and the at least one output parameter, are at least partially aggregated. It is also contemplated that the operational parameters associated with the time may be at least partially converted by the control unit, preferably in a conversion step, for adjustment to the physical model. Preferably, the operational parameters associated with the time, in particular in the conversion step, are converted to the input parameters and/or output parameters of the physical model as needed. For example, it is contemplated that the cell system comprises a plurality of stacks, each comprising a plurality of electrochemical cells, wherein averaging is performed over the individual stacks or that a sensed current of the cell system is converted to a current density. The physical model is preferably used to determine, in particular in a determination step, the aging parameter at a time, preferably the previously selected time, for which the physical model together with the at least one input parameter at the time, in particular the previously selected time, predicts the at least one, preferably the sensed, output parameter at the time, in particular the previously selected time. In particular, for determining the aging parameter, an optimization process, a Bayesian optimization, for example, a simulated annealing method, a gradient method or the like is used, preferably in the determining step, in particular with respect to the sensed output parameter of the cell system for the at least one input parameter of the, in particular the previously selected point in time and the output parameter predicted by the physical model with the input parameters of the selected point in time. The internal temperature parameter is determined as a function of the determined aging parameter, preferably in the determining step. Additionally, it is contemplated that the at least one further cell parameter of the cell system is determined as a function of the determined aging parameter, preferably in the determining step. Preferably, the internal temperature parameter, which is in particular one of the output parameters of the physical model, is determined based on the physical model as a function of the regression model which can be generated based on the physical model, in particular through an inversion and optimization of the physical model with respect to the aging parameter or from an aging parameter determined via a regression model which can be generated by the physical model. Advantageously, the internal temperature parameter can be determined from the operational parameters of the cell system without sensors. Advantageously, the internal temperature parameter can be determined with a particularly low need for sensor technology.

Further, it is proposed that the physical model be used to train a regression model, particularly the one mentioned above. Preferably, the regression model is trained based on results determined using the physical model. Preferably, the trained regression model is provided to replace the physical model at least for determining the aging parameter as a function of the operational parameters of the cell system. The regression model is particularly provided for use in an optimization process for determining the aging parameter or for directly determining the aging parameter based on the operational parameters. In particular, it is contemplated that the regression model will be trained such that the regression model determines the aging parameter of the cell system directly from the operational parameters sensed during operation, preferably from the at least one input parameter and the at least one output parameter, of the cell system, wherein in particular an inversion of the physical model is omitted. It is contemplated that the regression model may be trained using operational parameters sensed on the cell system and/or by statistical experimental design, for example, by Latin Hypercube sampling, active learning, or the like. In particular, the statistical experimental design is generated from a combination of operational parameters of the physical model, for which the aging parameter is determined based on the physical model, wherein results are used to train the regression model. For example, the training of the regression model is based on linear regression, on a random forest, on a Gaussian process, on a neural network, on an explainable boosting machine, or the like. Preferably, at least the aging parameter is determined while the cell system is in operation using the trained regression model. Advantageously, the internal temperature parameter can be determined in a particularly efficient manner with respect to time and computational effort required based on the aging parameter determined by the regression model.

Furthermore, it is proposed that the internal temperature parameter is determined in a spatially resolved manner. Preferably, a local distribution of the internal temperature parameter is determined. In particular, the spatially resolved internal temperature parameter corresponds to the local distribution of the internal temperature parameter. In addition, it is conceivable that the at least one further cell parameter, in particular the at least one further internal parameter, of the cell system is determined in a spatially resolved manner. The local distribution of the internal temperature parameter is in particular a local distribution of the internal temperature parameter within the cell system, preferably within the at least one electrochemical cell or within the stack formed from a plurality of electrochemical cells. In particular, the at least one operational parameter of the temperature control unit is set at least depending on the spatially resolved internal temperature parameter. Preferably, the spatially resolved internal temperature parameter is determined based on the physical model as a function of operational parameters of the cell system, preferably using the optimization methods applied to the inverted physical model with respect to the aging parameter or using the regression model generated using the physical model. In particular, the internal temperature parameter may be determined at a position or at a list of positions in the cell system. It is also contemplated that a combination of a plurality of further cell parameters of the cell system, preferably of a plurality of internal parameters of the cell system, for example a product, a sum, a non-linear function or the like, may be determined at the position or at the list of positions in the cell system. It is also contemplated that that derived values of the internal temperature parameter or of the combination of the plurality of further cell parameters, for example a maximum, a minimum an average in a partial volume or in a total volume of the cell system, are determined to describe the distribution, for example a first degree surface torque, a second degree surface torque, support points of a cumulative distribution density or the like, gradients or rates of change. Advantageously, knowledge of the local distribution of the internal temperature parameter allows for an increase in efficiency and dynamism of the cell system, for example by using an optimization of an operating strategy for the cell system. Advantageously, a particularly careful, precise and efficient operation of the cell system can be realized.

It is also proposed that expected behavior of the internal temperature parameter is predicted based on the physical model. Alternatively or additionally, it is also conceivable that an expected behavior of the at least one further cell parameter, in particular the at least one further internal parameter, the cell system and/or the aging parameter, is predicted based on the physical model. The aging parameter is determined as a function of the operational parameters of the cell system based on the physical model at a further point in time, in particular at a plurality of further points in time, preferably from the time series of the operational parameters, preferably analogously to the determination of the aging parameter at the previously selected point in time, for example by inverting and optimizing the physical model or by means of the regression model. The corresponding internal temperature parameter is preferably determined depending on the aging parameter determined at the further point in time, in particular at the plurality of further points in time, and the associated operational parameters based on the physical model. Preferably, a further regression model, in particular a temperature profile model, or the regression model is trained on the basis of the determined internal temperature parameter at different times and the corresponding operational parameters, preferably to map the behavior of the internal temperature parameter as a function of the operational parameters, and/or to preferably predict the expected behavior of the internal temperature parameter. The further regression model, in particular the temperature profile model, is in particular used to predict the expected curve of the internal temperature parameter. It is also contemplated that a curve over time of at least the internal temperature parameter of the cell system will be determined, in particular based on the determined internal temperature parameter at different times and the corresponding operational parameters. Additionally or alternatively, it is also conceivable that a curve over time of the at least one further cell parameter and/or the aging parameter is determined. Advantageously, damage to the cell system due to operation of the cell system in a critical temperature range can be counteracted particularly effectively. Advantageously, the cell system can be operated particularly carefully.

In addition, it is proposed that the at least one operational parameter of the temperature control unit be adjusted depending on the expected behavior of the internal temperature parameter. Preferably, the at least one operational parameter of the temperature control unit is adjusted depending on the expected behavior of the internal temperature parameter and/or depending on the internal temperature parameter determined, preferably at the current operational parameters, in particular based on the inversion and optimization of the physical model with respect to the aging parameter or based on the regression model. It is contemplated that the sensor signals of the sensing unit are at least partially taken into consideration during an adjustment, in particular by means of the control unit, of the at least one operational parameter of the temperature control unit. The temperature control unit preferably comprises a pilot component. Preferably, the pilot component is based on an energy balance, at which a storage term is determined as a sum of energy inflows minus a sum of the energy outflows. The storage term corresponds in particular to a multiplication of the thermal capacity by a change of the internal temperature parameter over time. The storage term may be integrally formulated for the entire cell system, in particular the entire at least one electrochemical cell or the entire stack formed by the plurality of electrochemical cells, or discretely, in particular, in a spatially-resolved manner, wherein the change of the internal temperature parameter over time is preferably provided starting from the physical model, in particular at least on the pilot component. Preferably, the control unit comprises the pilot component. The control unit or the temperature control unit preferably comprises at least one PID regulator. The PID regulator is preferably provided for empirical correction of model errors of the pilot component. The PID regulator can preferably access the internal temperature parameter determined, particularly based on the physical model, preferably a maximum value of the internal temperature parameter of the cell system. Advantageously, damage to the cell system due to operation of the cell system in a critical temperature range can be counteracted particularly effectively. Advantageously, the cell system can be operated particularly carefully.

In addition, a cell system, in particular the aforementioned cell system, is proposed with at least one, in particular the aforementioned electrochemical cell and with at least one control unit for performing the method according to the invention. Advantageously, a particularly durable cell system can be provided. Advantageously, a particularly dynamically operable cell system can be provided.

Furthermore, a computer program is proposed, comprising commands that, when the computer program is executed by a computer, prompt the latter to perform the method according to the disclosure. The computer program is preferably stored on the memory element of the control unit. Alternatively, it is also contemplated that the computer program may be stored on a portable data storage device, for example on a USB stick, on a portable hard drive, on an optical data storage device, in particular on a CD or the like, in a cloud, on a server, or the like. In particular, the control unit instructs the computer to carry out the computer program. Advantageously, the method for operating the cell system can be adjusted particularly conveniently and flexibly. Advantageously, the method can be applied to different cell systems, and in particular can be adapted to a specific cell system in a particularly convenient manner.

The method according to the invention, the cell system according to the invention and/or the computer program according to the invention is not intended to be limited to the application and embodiment described hereinabove. In particular, the method, the cell system according to the invention and/or the computer program according to the invention can comprise a number of individual elements, components, units, and method steps that deviates from a number specified herein for fulfilling a function described herein. Moreover, regarding the ranges of values indicated in this disclosure, values lying within the limits specified hereinabove are also intended to be considered as disclosed and usable as desired.

Further advantages follow from the description of the drawings hereinafter. The drawings illustrate an exemplary embodiment of the invention. The drawings, the description, and the claims contain numerous features in combination. A person skilled in the art will appropriately also consider the features individually and combine them into additional advantageous combinations.

### BRIEF DESCRIPTION OF THE DRAWINGS

Shown are:

FIG. 1 a schematic representation of a cell system according to the invention having at least one electrochemical cell and having at least one control unit for performing a method of operating the cell system, and

FIG. 2 a schematic procedure of the method according to the invention.

### DETAILED DESCRIPTION

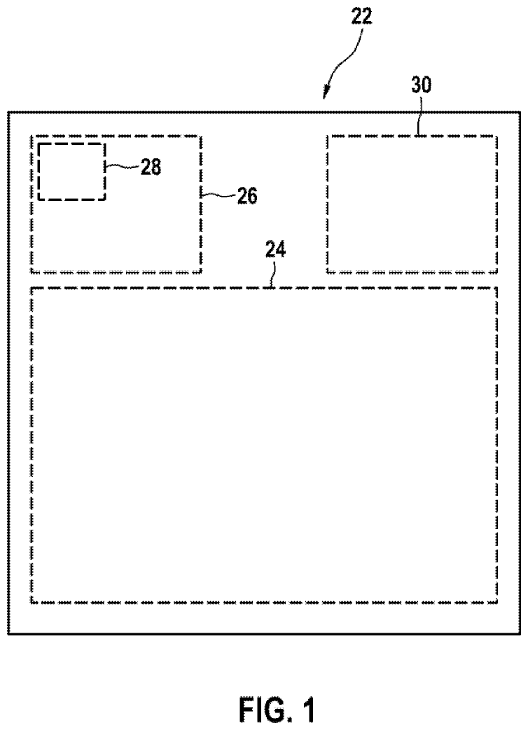

FIG. 1 shows a cell system 22 having a plurality of electrochemical cells 24 (in FIG. 1, by way of example, only one electrochemical cell 24 is shown). Alternatively, it is also contemplated that the cell system 22 only comprises one electrochemical cell 24. The electrochemical cells 24 are aggregated into a stack. It is also contemplated that the cell system 22 may comprise a plurality of stacks formed from a plurality of electrochemical cells 24, preferably aggregated to form a module or tower. The electrochemical cells 24 are connected in series. The electrochemical cells 24 are formed as solid oxide fuel cells. Alternatively, it is also contemplated that the electrochemical cells 24 may be formed as other types of fuel cells, such as polymer electrolyte membrane fuel cells or the like, as electrolytic cells, or as accumulator cells. For example, it is also contemplated that the electrochemical cells 24 may be used in an electrolyzer.

The cell system 22 comprises at least one control unit 26. The control unit 26 is provided to perform a method of operating the cell system 22. The control unit 26 is provided for adjusting at least one operational parameter of a temperature control unit 30 of the cell system 22 as a function of at least one internal temperature parameter of the cell system 22. The temperature parameter is a temperature of the cell system 22, preferably of the stack formed by a plurality of electrochemical cells 24. The internal temperature parameter is a cell parameter of the cell system 22, preferably an internal parameter of the cell system 22.

The control unit 26 comprises at least one processor (not shown here) and one memory element (not shown here) as well as an operating program stored on the memory element. The memory element is designed as a digital storage medium, e.g. as a hard disk or the like.

The cell system 22 comprises a housing (not shown here) in which the stack formed by a plurality of electrochemical cells 24 is disposed. It is contemplated that the control unit 26 may be disposed at least partially on, in particular at least partially in, the housing. Alternatively or additionally, it is also contemplated that the cell system 22 comprises an external unit (not shown here), wherein the external unit in particular comprises at least a portion of the control unit 26. For example, the external unit may be a cloud, a server, or the like. It is contemplated that the external unit comprises the storage element of the control unit 26.

A computer program 28 is stored on the storage element, comprising commands that, when executed by a computer, cause the computer program 28 to perform the method of operating the cell system 22. The control unit 26 comprises the computer. Alternatively, it is also contemplated that the computer program 28 may be stored on a portable disk, for example, a USB stick, on a portable hard drive, on an optical disk, particularly on a CD or the like, in a cloud, on a server, or the like.

The temperature control unit 30 comprises at least one blower unit (not shown here). The temperature control unit 30, in particular the blower unit, is provided to generate an air flow rate, preferably on a cathode side (not shown here) of the cell system 22. By means of the blower unit, in particular by means of the air flow rate generated by the blower unit, oxygen ions required for an electrochemical reaction of the cell system 22 are provided. The cell system 22, in particular the stack formed by a plurality of electrochemical cells 24, is temperature controlled by means of the temperature control unit 30. The cell system 22, in particular the stack formed by a plurality of electrochemical cells 24, is in particular cooled by means of the temperature control unit 30. The blower unit is provided to generate an air flow rate for cooling the cell system 22, in particular the stack formed by a plurality of electrochemical cells 24. It is contemplated that the blower unit may comprise one fan or multiple fans. Alternatively or additionally, it is also conceivable that the cell system 22, in particular the stack formed by a plurality of electrochemical cells 24, is heated by means of the temperature control unit 30, in particular at least by means of the blower unit. In particular, it is additionally or alternatively conceivable that the blower unit is provided to generate an air flow rate, preferably pre-heated, for heating the cell system 22, in particular the stack formed by a plurality of electrochemical cells 24.

Alternatively or additionally, it is also conceivable that the temperature control unit 30 comprises a heating unit for heating the cell system 22, in particular the stack formed by a plurality of electrochemical cells 24. For example, the heating unit may be configured as an electric heating unit. In particular, the heating unit comprises at least one heating element, preferably an electric heating element. Alternatively, however, it is also conceivable that the heating unit is configured as a fluid-based heating unit, in particular as a liquid-based heating unit and/or as a gas-based heating unit. The fluid-based heating unit is particularly provided for heating the cell system 22, in particular the stack formed by a plurality of electrochemical cells 24, using a fluid. The liquid-based heating unit is particularly provided for heating the cell system 22, in particular the stack formed by a plurality of electrochemical cells 24, by means of a liquid, for example water or the like. The gas-based heating unit is provided for heating the cell system 22, in particular the stack formed by a plurality of electrochemical cells 24, using a gas. Further, it is contemplated that the heating unit may be configured as a combination of a fluid-based heating unit, in particular a gas-based heating unit and/or a liquid-based heating unit, and an electric heating unit.

Alternatively or additionally, it is also contemplated that the temperature control unit 30 comprises a fluid cooling unit, in particular a liquid cooling unit and/or a gas cooling unit, for cooling the cell system 22, in particular the stack formed by a plurality of electrochemical cells 24. The fluid cooling unit is particularly provided for cooling the cell system 22 using a fluid. The liquid cooling unit is particularly provided to cool the cell system 22, in particular the stack formed by a plurality of electrochemical cells 24, using a liquid, for example water, or the like. It is contemplated that the liquid cooling unit is formed to be at least partially integral with the liquid-based heating unit. It is also contemplated that the gas cooling unit is formed to be at least partially integral with the gas-based heating unit. The gas cooling unit is particularly provided for cooling the cell system 22, in particular the stack formed by a plurality of electrochemical cells 24, by means of a gas.

The at least one operational parameter of the temperature control unit 30 comprises at least one flow rate of the blower unit. Alternatively or additionally, it is contemplated that the at least one operational parameter of the temperature control unit 30 comprises a heating power of an, in particular electrical, heating unit, a flow rate of the fluid-based heating unit, in particular, a flow rate of the liquid-based heating unit and/or a flow rate of the gas-based heating unit, a flow rate of the fluid cooling unit, preferably a flow rate of the liquid cooling unit and/or a flow rate of the gas cooling unit, or another operational parameter of the temperature control unit 30 which appears reasonable to a person skilled in the art.

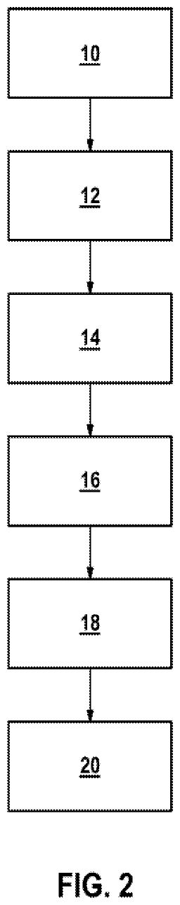

FIG. 2 shows a schematic procedure for the method of operating the cell system 22. In a method step of the method, in particular a sensing step 10, operational parameters of the cell system 22 are at least partially sensed on the cell system 22. The operational parameters include a plurality of input parameters of the cell system 22, or alternatively, only one input parameter of the cell system 22. The input parameters of the cell system 22 are operational parameters of the cell system 22, here by way of example a requested load current, a temperature, in particular a gas temperature, a volume flow, a gas composition, a pressure, a pressure difference, or the like. It is contemplated that the operational parameters of the cell system 22 are at least partially variables or control variables, in particular actual values or target values for the control variables, of the cell system 22.

The operational parameters comprise at least one output parameter of the cell system 22. It is also contemplated that the operational parameters comprise a plurality of output parameters of the cell system 22. The output parameter of the cell system 22 comprises a performance parameter of the cell system 22. The performance parameter of the cell system 22 is an output voltage of the cell system 22, in particular the stack formed by a plurality of electrochemical cells 24.

The cell system 22 comprises a sensing unit (not shown here) for at least partially sensing the operational parameters of the cell system 22. The sensing unit is connected to the control unit 26 via data technology, in particular for wireless and/or wired data transmission. It is also contemplated that the control unit 26 at least partially comprises the sensing unit. The sensing unit comprises a sensor unit for at least partially sensing the operational parameters. The sensing unit, in particular the sensor unit, is configured to sense at least the output parameter of the cell system 22 configured as the performance parameter, in particular using sensors. For example, the sensor unit comprises at least one voltage sensor, in particular for sensing the performance parameter of the cell system 22 configured as the output voltage.

It is contemplated that the operational parameters configured as input parameters of the cell system 22 may be at least partially able to be sensed by means of the sensing unit, preferably using sensors. In addition or alternatively, it is also conceivable that the input parameters, preferably the input parameters configured as variables or control variables, in particular the target values of the parameters configured as control variables, are read at least in part directly by the control unit 26 in the sensing step 10, preferably by the control unit 26.

The operational parameters, in particular the input parameters and the output parameter, of the cell system 22 are recorded over time in the sensing step 10. Time series are formed based on the recorded operational parameters. The recorded operational parameters are stored as time series on the control unit 26, in particular on the storage element of the control unit 26.

In a method step of the method, in particular in a selection step 12, a time is selected from the time series of the operational parameters, preferably by the control unit 26. The control unit 26 is provided to determine at least one aging parameter of the cell system 22 for the selected point in time. The control unit 26 is provided to select the point in time from the time series of the operational variables such that a system state of the cell system 22 associated with the point in time can be described by a physical model for the cell system 22. For example, it is conceivable that the physical model is only applicable to steady state conditions, in particular input parameters of the cell system 22, so that sufficient steady state operational parameters are to be used accordingly.

The physical model is a simulation model of the cell system 22, which in particular describes a steady state operation of the cell system 22. The physical model is based on the finite element method. The physical model is unambiguously invertable at least with regard to the aging parameter.

It is contemplated that the physical model will be unambiguously invertable with respect to the aging parameter at least by filtering out physically irrelevant results of the physical model. For example, according to a publication by Zaccaria, Tucker and Traverso entitled “A distributed real-time model of degradation in a solid oxide fuel cell” (2016, Journal of Power Sources 311, 175-181), the physical model may describe a degradation of the cell system 22, wherein an ohmic portion of internal voltage losses is pre-factored with the aging parameter.

Alternatively, it is also conceivable, for example, that other resistors of internal voltage losses differing from the ohmic portion, in particular the concentration losses or polarization losses, of the cell system 22 or an overall internal resistance of the cell system 22, are multiplied by the aging parameter as a pre-factor. In the preferred physical model, an overall specific surface resistance of the cell system 22 is multiplied by the aging parameter. The aging parameter describes an aging state of the cell system 22. The aging parameter has a value of 1 in an unaged state of the cell system 22 and a value greater than 1 in an aged state of the cell system 22. The aging parameter is a scalar parameter.

The physical model comprises multiple input parameters and multiple output parameters. Alternatively, it is also conceivable that the physical model only comprises one input parameter and/or only one output parameter. The input parameters of the physical model are at least partially operational parameters of the cell system 22. The input parameters of the physical model comprise the aging parameter of the cell system 22. The input parameters of the physical model comprise the operational parameters of the cell system 22. The output parameters of the physical model comprise at least one of the operational parameters of the cell system 22, in particular the output parameter of the cell system 22 configured as the performance parameter of the cell system 22. The output parameters of the physical model comprise at least the internal temperature parameter. It is contemplated that the output parameters of the physical model comprise at least one further cell parameter of the cell system 22, preferably at least one further internal parameter of the cell system 22. For example, the at least one further internal parameter of the cell system 22 may be a fluid distribution, preferably an oxygen distribution or a hydrogen distribution, in the cell system 22, a current density distribution in the cell system 22, or the like.

In particular, the physical model depicts a mapping which maps the input parameters of the physical model, preferably the operational parameters of the cell system 22 and the aging parameter of the cell system 22 to the output parameters of the physical model, preferably the performance parameter of the cell system 22, the internal temperature parameter of the cell system 22, and preferably the at least one further internal parameter of the cell system 22.

It is contemplated that the operational parameters associated at the time may be at least partially converted to match the physical model in a method step, in particular in a conversion step 14, preferably by the control unit 26. The operational parameters associated with the point in time are converted, in particular in the conversion step 14, to the input parameters and/or output parameters of the physical model as needed. It is also contemplated that the operational parameters may be at least partially pre-processed, for example oscillations or the like may be removed by a filter. It is further contemplated that the operational parameters will be at least partially aggregated, in particular in the conversion step 14.

Based on the physical model, in a method step, in particular in a determination step 16, the aging parameter is determined at the selected time for which the physical model, together with the input parameters, predicts the sensed output parameter, in particular the performance parameter at the selected time. To determine the aging parameter, the physical model is inverted and optimized in the determining step 16, in particular with respect to the aging parameter.

In the determination step 16, an optimization method is applied to determine the aging parameter, for example a Bayesian optimization, a simulated annealing method, a gradient method, or the like, in particular regarding the sensed output parameter of the cell system 22 at the input parameters of the selected point in time and the output parameter predicted by the physical model at the input parameters of the selected point in time.

The physical model of the cell system 22 is used to determine the internal temperature parameter and the at least one further cell parameter as a function of the operational parameter of the cell system 22. The internal temperature parameter and the at least one further cell parameter are determined based on the physical model of the cell system 22. The physical model is inverted and optimized with respect to the aging parameter, which is in particular one of the input parameters of the physical model, in order to determine the aging parameter and subsequently determine the internal temperature parameter and preferably the at least one further cell parameter based on the physical model as a function of the determined aging parameter.

The internal temperature parameter is determined as a function of the determined aging parameter, preferably in the determining step 16. Additionally, it is contemplated that the at least one further cell parameter of the cell system 22 is determined as a function of the determined aging parameter, preferably in the determining step 16. The internal temperature parameter, which is in particular one of the output parameters of the physical model, is determined based on the physical model as a function of the regression model which can be generated based on the physical model, in particular through an inversion and optimization of the physical model with respect to the aging parameter or from an aging parameter determined via a regression model which can be generated by the physical model.

It is also contemplated that the physical model will be used to train a regression model, in particular the model already mentioned above. The regression model is trained on results determined using the physical model. The trained regression model is provided to replace the physical model at least when determining the aging parameter as a function of the operational parameters of the cell system 22. The regression model is particularly provided for use in an optimization process for determining the aging parameter or for directly determining the aging parameter based on the operational parameters. It is contemplated that the regression model will be trained such that the regression model will determine the aging parameter directly from the operational parameters sensed during operation, preferably the at least one input parameter and the at least one output parameter, of the cell system 22, wherein in particular inversion of the physical model is omitted. The regression model is trained using operational parameters sensed on the cell system 22 and/or by statistical experimental design, for example, Latin Hypercube sampling, active learning, or the like. In particular, the statistical experimental design is generated from a combination of operational parameters of the physical model, for which the aging parameter is determined based on the physical model, wherein results are used to train the regression model. For example, the training of the regression model is based on linear regression, on a random forest, on a Gaussian process, on a neural network, on an explainable boosting machine, or the like. The aging parameter is determined during operation of the cell system 22 based on the trained regression model.

The internal temperature parameter is determined, in particular in the determination step 16, in a spatially resolved manner. In addition, it is conceivable that the at least one further cell parameter, in particular the at least one further internal parameter of the cell system 22, is determined in a spatially resolved manner. In the determining step 16, a local distribution of the internal temperature parameter is determined. In particular, the spatially resolved internal temperature parameter corresponds to the local distribution of the internal temperature parameter. The local distribution of the internal temperature parameter is a local distribution of the internal temperature parameter within the cell system 22, particularly within the stack formed from a plurality of electrochemical cells 24. The local distribution of the internal temperature parameter is determined based on the physical model as a function of operational parameters of the cell system 22, preferably by the optimization method applied to the inverted physical model or by the regression model generated by the physical model. The internal temperature parameter may be determined at a position or at a list of positions in the cell system 22. It is also contemplated that a combination of a plurality of cell parameters of the cell system 22, preferably of a plurality of internal parameters of the cell system 22, for example a product, a sum, a non-linear function or the like, may be determined at the position or at the list of positions in the cell system 22. It is also contemplated that that derived values of the internal temperature parameter or of the combination of the plurality of cell parameters, for example a maximum, a minimum an average in a partial volume or in a total volume of the cell system 22, are determined to describe the distribution, for example a first degree surface torque, a second degree surface torque, support points of a cumulative distribution density or the like, gradients or rates of change.

In a method step, in particular in an evaluation step 18, an expected behavior of the internal temperature parameter is predicted based on the physical model. Alternatively or additionally, it is also conceivable that an expected behavior of the at least one further cell parameter, in particular at least one further internal parameter, of the cell system 22 and/or the aging parameter is predicted based on the physical model. The aging parameter is determined as a function of the operational parameters of the cell system 22 based on the physical model at a further point in time, in particular at a plurality of further points in time, preferably from the time series of the operational parameters, preferably analogously to the determination of the aging parameter at the previously selected point in time, for example by inverting and optimizing the physical model or by means of the regression model. The corresponding internal temperature parameter is determined depending on the aging parameter determined at the further point in time, in particular at the plurality of further points in time, and the associated operational parameters based on the physical model.

In the evaluation step 18, a further regression model, in particular a temperature profile model, or the regression model is trained on the basis of the determined internal temperature parameter at different times and the corresponding operational parameters, in particular to map the behavior of the internal temperature parameter as a function of the operational parameters and/or to predict the expected behavior of the internal temperature parameter. The further regression model, in particular the temperature profile model, or the regression can in particular be used to predict the expected curve of the internal temperature parameter.

It is also contemplated that a curve over time of at least the internal temperature parameter of the cell system 22 will be determined, in particular based on the determined internal temperature parameter at different times and the corresponding operational parameters. Additionally or alternatively, it is also conceivable that a curve over time of the at least one further cell parameter and/or the aging parameter is determined.

In an adjustment step 20, the at least one operational parameter of the temperature control unit 30 is set as a function of the internal temperature parameter. In the adjustment step 20, the at least one operational parameter of the temperature control unit 30, is set, in particular by way of the control unit 26, depending on at least the internal temperature parameter of the cell system 22, in particular as a function of the expected behavior of the internal temperature parameter and/or as a function of the internal temperature parameter, preferably determined relative to current operational parameters, based in particular on the inversion and optimization of the physical model or based on the regression model. The at least one operational parameter of the temperature control unit 30 is set at least depending on the local distribution of the internal temperature parameter.

It is contemplated that sensor signals of the sensing unit may be taken into account at least partially during a setting step 20, in particular using the control unit 26, of the at least one operational parameter of the temperature control unit 30. The temperature control unit 30 has a pilot component (not shown here). The pilot component is based on an energy balance, at which a storage term is determined as a sum of energy inflows minus a sum of the energy outflows. The storage term corresponds in particular to a multiplication of the thermal capacity by a change of the internal temperature parameter over time. The storage term may be integrally formulated for the entire cell system 22, in particular the entire stack formed by the plurality of electrochemical cells 24, or discretely, in particular, in a spatially-resolved manner, wherein a change over time of the internal temperature parameter is provided starting from the physical model, in particular at least on the pilot component. The control unit 26 comprises the pilot component. The control unit 26, in particular the temperature control unit 30, comprises at least one PID regulator. The PID regulator is provided for empirical correction of model errors of the pilot component. The PID regulator can access the internal temperature parameter determined particularly based on the physical model, and in particular a maximum value of the internal temperature parameter of the cell system 22.

1. A method for operating a cell system (22) with at least one electrochemical cell (24), wherein at least one operational parameter of a temperature control unit (30) of the cell system (22) is set as a function of at least one internal temperature parameter of the cell system (22).

2. The method of claim 1, wherein the internal temperature parameter is determined based on a physical model of the cell system (22).

3. The method of claim 2, wherein the internal temperature parameter is determined on the basis of the physical model of the cell system (22) as a function of the operational parameter of the cell system (22).

4. The method of claim 3, wherein the operational parameters comprise at least one input parameter of the cell system (22).

5. The method of claim 4, wherein the input parameter comprises at least one operational parameter of the cell system (22).

6. The method of claim 3, wherein the operational parameters comprise at least one output parameter of the cell system (22).

7. The method of claim 6, wherein the output parameter comprises at least one performance parameter of the cell system (22).

8. A method according to claim 1, wherein the physical model is inverted and optimized to determine the internal temperature parameter.

9. A method according to claim 1, wherein the physical model is used to train a regression model.

10. A method according to claim 1, wherein the internal temperature parameter is determined in a spatially resolved manner.

11. A method according to claim 1, wherein an expected behavior of the internal temperature parameter is predicted based on the physical model.

12. The method of claim 11, wherein the at least one operational parameter of the temperature control unit (30) is adjusted as a function of the expected behavior of the internal temperature parameter.

13. A cell system (22) having at least one electrochemical cell (24) and having at least one control unit (26) for performing a method according to claim 1.

14. A non-transitory, computer-readable medium comprising instructions which, when executed by a computer, prompt the latter to perform the method according to claim 1.
